(19) United States
(12) Patent Application Publication
(10) Pub. No.: US 2025/0011959 A1
(43) Pub. Date: Jan. 9, 2025

(54) METHODS AND SYSTEMS OF CONTROLLING BIDIRECTIONAL OPERATION OF AN ELECTROWINNING PLANT

(71) Applicant: FORM ENERGY, INC., Somerville, MA (US)

(72) Inventors: Liang SU, Medfield, MA (US); Karen THOMAS-ALYEA, Arlington, MA (US); Janna RATHERT, Somerville, MA (US); Jeffrey POIRIER, Sumerville, MA (US); Joseph Stephen MANSER, Lowell, MA (US)

(21) Appl. No.: 18/763,736

(22) Filed: Jul. 3, 2024

Related U.S. Application Data
(60) Provisional application No. 63/511,769, filed on Jul. 3, 2023.

(51) Int. Cl. C25C 7/06; C25C 7/02; H01M 12/08

(52) U.S. Cl. CPC C25C 7/06; C25C 7/02; H01M 12/08

(57) ABSTRACT

Methods and systems of the present disclosure are generally directed to switching operation of one or more electrochemical cells of an electrowinning plant between a charge mode and a discharge mode. In the charge mode, the one or more electrochemical cells may reduce metal from an oxidized state to a zero valence state with a first electric current applied across the one or more electrochemical cells. In the discharge mode, the one or more electrochemical cells may oxidize at least some of the metal from the zero valence state to the oxidized state to generate a second electric current, oppositely charged relative to the first electric current, to generate electricity (e.g., for delivery to the grid). Operation of the one or more electrochemical cells of the electrowinning plant may be selectively changed between the charge mode and the discharge mode based on, for example, availability/cost of electricity from the grid.

### CROSS-REFERENCE TO RELATED APPLICATIONS

This application claims the benefit of priority to U.S. Provisional Patent Application 63/511,769, filed Jul. 3, 2023, the entire contents of which are hereby incorporated herein by reference.

### BACKGROUND

During charge operation, an electrowinning plant consumes electricity to produce a product metal from ore. However, markets for both metal and electricity are highly volatile. Metal prices are affected, for example, by demand for metal (e.g., varying as needs for construction materials change) and by supply from competing sources of product metal. Electricity markets typically vary according to factors such as time of day, season of the year, and weather conditions. For cost reasons, some electrowinning plants reduce electricity consumption, and thus production of product metal, when electricity prices are high (e.g., during hot afternoons). Further, given that high demand on the electricity grid may cause blackouts in some cases, grid utilities may offer electrowinning plants a fixed amount of money each month, in return for the plant committing to reducing consumption during times of high electricity prices.

Accordingly, there remains a need for managing operation of electrowinning plants to facilitate achieving robust cost-effectiveness and profitability through volatility associated with metal and electricity markets.

### SUMMARY

Methods and systems of the present disclosure are generally directed to switching operation of one or more electrochemical cells of an electrowinning plant between a charge mode and a discharge mode. In the charge mode, the one or more electrochemical cells may reduce metal from an oxidized state to a zero valence state with a first electric current applied across the one or more electrochemical cells. In the discharge mode, the one or more electrochemical cells may oxidize at least some of the metal from the zero valence state to the oxidized state to generate a second electric current, oppositely charged relative to the first electric current, to generate electricity (e.g., for delivery to the grid). Operation of the one or more electrochemical cells of the electrowinning plant may be selectively changed between the charge mode and the discharge mode based on, for example, availability/cost of electricity from the grid.

According to one aspect, a method of controlling bidirectional operation of an electrowinning plant may include receiving a supply of metal in an oxidized state into at least one electrochemical cell; operating the at least one electrochemical cell in a charge mode in which a first electric current applied across the electrochemical cell reduces the metal from the oxidized state to a zero valence state in the electrochemical cell; operating the at least one electrochemical cell in a discharge mode in which oxidation of at least some of the metal from the zero valence state to the oxidized state in the electrochemical cell generates a second electric current oppositely charged relative to the first electric current; and selectively changing operation of the at least one electrochemical cell between the charge mode and the discharge mode.

In some implementations, metal in the oxidized state may include metal ore.

In certain implementations, the metal may include one or more of iron, copper, zinc, nickel, manganese, lead, aluminum, or cobalt.

In some implementations, operating the at least one electrochemical cell in the discharge mode may include inserting an additional amount of the metal in the zero valence state into the electrochemical cell.

In certain implementations, operating the at least one electrochemical cell in the charge mode may include receiving power from a power network to apply the first electric current across the electrochemical cell, and operating the at least one electrochemical cell in the discharge mode includes delivering, to the power network, at least some of the power generated by the electrochemical cell. The power network may be an electrical grid. For example, the electrical grid may be a bulk grid or a micro-grid.

In some implementations, operating the at least one electrochemical cell in the charge mode may include applying the first electric current across a negative electrode and at least one positive electrode, via an electrolyte therebetween, with the negative electrode including the metal in the oxidized state. Operating the at least one electrochemical cell in the discharge mode may include generating the second electric current across the negative electrode and the at least one positive electrode, via the electrolyte therebetween, with the negative electrode including metal in the zero valence state. Further, or instead, receiving the supply of metal in the oxidized state into the at least one electrochemical cell may include dissolving the metal in the oxidized state in a solution with the electrolyte and pumping the solution into the at least one electrochemical cell. Still further, or instead, receiving the supply of metal in the oxidized state into the at least one electrochemical cell may include providing a solid form of metal ore to the negative electrode of the at least one electrochemical cell. The at least one positive electrode may be a bifunctional oxygen electrode in electrical communication with the negative electrode in each of the charge mode and the discharge mode. Further, or instead, the at least one positive electrode may include a charge positive electrode and a discharge positive electrode. For example, selectively changing operation of the at least one electrochemical cell between the charge mode and the discharge mode may include selective electrical isolation of the negative electrode from one of the charge positive electrode and the discharge positive electrode depending on operation mode of the at least one electrochemical cell. As a specific example, selective electrical isolation of the negative electrode from one of the charge positive electrode and the discharge positive electrode may include interrupting electrical communication between the discharge positive electrode and the negative electrode as the charge positive electrode and the negative electrode are in electrical communication with one another in an electric circuit including the electrolyte. In some instances, the charge positive electrode has pores through which electrolyte is transportable from the negative electrode to the discharge positive electrode, and interrupting electrical communication between the discharge positive electrode and the negative electrode may include removing the discharge positive electrode from the electrolyte. As another example, the charge positive electrode may be nonporous and interrupting electrical communication between the discharge positive electrode and the negative electrode may include positioning the charge positive electrode in the electrolyte, between the discharge positive electrode and the negative electrode. As an example, the charge positive electrode positioned in the electrolyte, between the discharge positive electrode and the negative electrode, may block substantially all transport of electrolyte to the discharge positive electrode. Further, or instead, interrupting electrical communication between the discharge positive electrode and the negative electrode may include positioning a shield between the discharge positive electrode and the charge positive electrode in the electrolyte, and the shield is electrically insulating and fluid impermeable. Still further or instead, selectively changing operation of the at least one electrochemical cell between the charge mode and the discharge mode may include removing the charge positive electrode from the electrolyte and placing the discharge positive electrode into the electrolyte for operation of the at least one electrochemical cell in the discharge mode, and removing the discharge positive electrode from the electrolyte and placing the charge positive electrode into the electrolyte for operation of the at least one electrochemical cell in the charge mode. In some instances, selectively changing operation of the at least one electrochemical cell between the charge mode and the discharge mode may include selectively completing and/or interrupting a first circuit including the negative electrode and the charge positive electrode, and selectively completing and/or interrupting a second circuit including the negative electrode and the discharge positive electrode.

In certain implementations, a gaseous molecule may be flowable through a gas flow field adjacent to the positive electrode, the gaseous molecule includes a first molecule in the charge mode, and the gaseous molecule includes a second molecule in the discharge mode. The first molecule and the second molecule may be the same. For example, the first molecule may be chlorine generated during charge. Further, or instead, the first molecule may be hydrogen oxidized during charge. Additionally, or alternatively, the second molecule may be oxygen reduced during discharge.

In some implementations, selectively changing operation of the at least one electrochemical cell between the charge mode and the discharge mode may include operating the at least one electrochemical cell in the discharge mode for greater than about 1 percent and less than about 13 percent of time that the at least one electrochemical cell is in the charge mode.

In certain implementations, selectively changing operation of the at least one electrochemical cell between the charge mode and the discharge mode may include operating the at least one electrochemical cell in the charge mode for about 1 day to about 30 days between harvesting.

In some implementations, selectively changing operation of the at least one electrochemical cell may be based on a parameter associated with operation of the at least one electrochemical cell compared to a predetermined target value of the parameter. For example, the parameter associated with operation of the at least one electrochemical cell may be cost associated with applying the first electric current across the at least one electrochemical cell to operate the at least one electrochemical cell in the charge mode.

In certain implementations, the at least one electrochemical cell may include a plurality of electrochemical cells, operating the at least one electrochemical cell in the charge mode includes operating a first one of the plurality of electrochemical cells in the charge mode, operating the at least one electrochemical cell in the discharge mode includes operating a second one of the plurality of electrochemical cells in the discharge mode, and selectively changing operation of the at least one electrochemical cell between the charge mode and the discharge mode includes controlling electrical communication between a power network and the first one and the second one of the plurality of electrochemical cells.

In some implementations, the method may further, or instead, include harvesting at least a portion of the metal in the zero valence state from the at least one electrochemical cell.

According to another aspect, a system for bidirectional operational control of an electrowinning plant may include at least one electrochemical cell into which a supply of metal is receivable; and a controller actuatable to change operation of the one or more electrochemical cells between a charge mode and a discharge mode, the one or more electrochemical cells in the charge mode operable to reduce metal from an oxidized state to a zero valence state in response to a first electric current applied to the one or more electrochemical cells, and the one or more electrochemical cells in the discharge mode operable to oxidize the metal from the zero valence state to the oxidized state such that a second electric current, oppositely charged relative to the first electric current, is generated by the one or more electrochemical cells.

In some implementations, the at least one electrochemical cell may include at least one positive electrode, a negative electrode, an electrolyte in fluid communication between the at least one positive electrode and the negative electrode, the at least one electrochemical cell is operable in the charge mode with the first electric current applied across the negative electrode and the at least one positive electrode, via the electrolyte therebetween and with the negative electrode including the metal in the oxidized state, and the at least one electrochemical cell is operable in the discharge mode with the second electric current generated across the negative electrode and the at least one positive electrode, via the electrolyte therebetween and with the negative electrode including metal in the zero valence state. In some instances, the system may further include a pump operable to pump the metal in the oxidized state, dissolved in a solution with the electrolyte and/or as solid particles in the electrolyte, into the negative electrode. Further, or instead, the negative electrode may be removable from the at least one electrochemical cell and, with the negative electrode removed from the electrochemical cell, at least a portion of the metal in the zero valence state is harvestable from the negative electrode. Additionally, or alternatively, the at least one positive electrode may include a charge positive electrode and a discharge positive electrode, and each one of the charge positive electrode and the discharge positive electrode is electrically decouplable from the negative electrode and from one another. As an example, the controller may be actuatable to complete and/or interrupt a first circuit including the negative electrode and the charge positive electrode, and to complete and/or interrupt a second circuit including the negative electrode and the discharge positive electrode. As a specific example, the controller may be actuatable to isolate the negative electrode electrically from one of the charge positive electrode and the discharge positive electrode depending on operation mode of the at least one electrochemical cell. In some instances, the controller may be in electrical communication with an actuator operable to move one or more portions of the at least one electrochemical cell to interrupt electrical communication between the discharge positive electrode and the negative electrode as the charge positive electrode and the negative electrode are in electrical communication with one another via the electrolyte in charge mode operation of the at least one electrochemical cell. For example, the actuator may be in mechanical communication with the discharge positive electrode, the controller is operable to actuate the actuator to remove the discharge positive electrode from the electrolyte in charge operation of the at least one electrochemical cell, and the controller is operable to actuate the actuator to position the discharge positive electrode in the electrolyte in discharge operation of the at least one electrochemical cell. Further, or instead, the charge positive electrode may be nonporous, the controller is operable to actuate the actuator to position the charge positive electrode in the electrolyte, between the discharge positive electrode and the negative electrode, in the charge mode operation of the at least one electrochemical cell, and the controller is operable to actuate the actuator to remove the charge positive electrode from the electrolyte in discharge mode operation of the at least one electrochemical cell. In some instances, the system may further include a frame disposed in the electrolyte between the discharge positive electrode and the negative electrode, wherein the frame and the charge positive electrode in the electrolyte, between the discharge positive electrode and the negative electrode, collectively block electrolyte from transporting to an active surface of the discharge positive electrode. Additionally, or alternatively, in discharge mode, the discharge positive electrode is in electrical communication with the negative electrode in the electrochemical cell via the electrolyte and the charge positive electrode is outside of the electrolyte of the electrochemical cell. Further, or instead, in the charge mode, the charge positive electrode may be in electrical communication with the negative electrode in the electrochemical cell via the electrolyte and the discharge positive electrode is outside of the electrolyte of the electrochemical cell. In certain instances, the system may further include a shield, wherein the shield is electrically insulating and fluid impermeable, the shield movable between the discharge positive electrode and the charge positive electrode in the electrolyte, wherein the controller is operable to actuate the actuator to move the shield between the discharge positive electrode and the charge positive electrode in the electrolyte in charge mode operation of the at least one electrochemical cell. For example, the charge positive electrode may define pores through which, in the absence of the shield between the discharge positive electrode and the charge positive electrode in the electrolyte, the electrolyte is transportable between the negative electrode and the discharge positive electrode. In some instances, the at least one positive electrode may include a bifunctional oxygen electrode having hydrophobic pores and hydrophilic pores. Further, or instead, the at least one positive electrode may include a flow field through which a gaseous molecule is flowable in at least one of the charge mode or the discharge mode. For example, a first gaseous molecule is flowable through the positive electrode in the discharge mode and a second gaseous molecule, different from the first gaseous molecule, is flowable to through the positive electrode in the charge mode.

In some implementations, the controller may be actuatable to activate one or more switches in electrical communication between the at least one electrochemical cell and a power network to change operation of the at least one electrochemical cell between the charge mode and the discharge mode, power from the power network is receivable by the at least one electrochemical cell in the charge mode, and at least some of the power generated by the at least one electrochemical cell is deliverable to the power network with the at least one electrochemical cell in the discharge mode.

In certain implementations, the at least one electrochemical cell may be operable in the discharge mode for greater than about 1 percent and less than about 13 percent of the time the at least one electrochemical cell is in the charge mode.

In some implementations, the controller may be actuatable to change operation of the at least one electrochemical cell such that the at least one electrochemical cell operates in the charge mode for about 1 day to about 30 days between harvesting.

In certain implementations, the at least one electrochemical cell may include a plurality of electrochemical cells, a first one of the plurality of electrochemical cells is operable in the charge mode, a second one of the plurality of electrochemical cells is operable in the discharge mode, and the controller is actuatable to control electrical communication between a power network and the first one and the second one of the plurality of electrochemical cells.

According to yet another aspect, an electrowinning plant may include a feedstock including metal in an oxidized state; one or more systems above, the feedstock movable into the at least one electrochemical cell, the at least one electrochemical cell operable in the charge mode to form the metal in the oxidized state into the metal in a zero valence state, the at least one electrochemical cell operable in the discharge mode to generate the second electric current from the metal in the zero valence state; and a repository of the metal in the zero valence state, the metal in the zero valence state harvestable from the at least one electrochemical cell and storable in the repository.

### BRIEF DESCRIPTION OF THE DRAWINGS

FIG. 1A is a schematic representation of a portion of an electrowinning plant, the portion of the electrowinning plant including a feedstock, a system for bidirectional operational control of the electrowinning plant, and a repository, the feedstock including metal in an oxidized state, the repository including metal in the zero valence state, and the system for bidirectional operational control of the electrowinning plant including a controller and an electrochemical cell, wherein a negative electrode of an electrochemical cell of the system is shown being removed from the electrochemical cell for storage in the repository.

FIG. 1B is a schematic representation of the portion of the electrowinning plant of FIG. 1B, portion of the electrowinning plant shown with the controller controlling the electrochemical cell in a charge mode.

FIG. 1C is a schematic representation of the portion of the electrowinning plant of FIG. 1B, the portion of the electrowinning plant shown with the controller controlling the electrochemical cell in a discharge mode.

FIG. 2 is a flowchart of an exemplary method of controlling bidirectional operation of an electrowinning plant.

FIG. 3A is a schematic representation of an electrochemical cell of a system for bidirectional operational control of an electrowinning plant, the electrochemical cell including a negative electrode, a charge positive electrode, a discharge positive electrode, a first switch, and a second switch, and the electrochemical cell shown with the first switch closed and coupling the charge positive electrode in a completed electrical circuit with the negative electrode and the second switch open and disconnecting the discharge positive electrode from the electrical circuit.

FIG. 3B is a schematic representation of the electrochemical cell of FIG. 3A, shown with the first switch open and disconnecting the charge positive electrode from the electrical circuit and the second switch closed and coupling the discharge positive electrode in a completed electrical circuit with the negative electrode.

FIG. 4 is a schematic representation of an electrochemical cell including a negative electrode, an electrolyte, a charge positive electrode, and a discharge positive electrode, with the discharge positive electrode shown lifted out of the electrolyte.

FIG. 5A is a schematic representation of an electrochemical cell including a negative electrode, an electrolyte, a charge positive electrode, and a discharge positive electrode, the charge positive electrode is shown at least partially immersed in the electrolyte, and the charge positive electrode is liftable out of the electrolyte while the negative electrode and the discharge positive electrode remain at least partially immersed in the electrolyte.

FIG. 5B is a schematic representation of the electrochemical cell of FIG. 5A, shown with the charge positive electrode lifted out of the electrolyte.

FIG. 6 is a schematic representation of a system for bidirectional operational control of an electrowinning plant, with the system including a first electrochemical cell for charge mode and a second electrochemical cell for discharge mode.

FIG. 7 is a schematic representation of a portion of an electrowinning plant operable to fit charge positive electrodes and discharge positive electrodes into the same position in an electrochemical cell.

Like reference symbols in the various drawings indicate like elements.

### DETAILED DESCRIPTION

Embodiments will now be described more fully hereinafter with reference to the accompanying figures, in which exemplary embodiments are shown. The foregoing may, however, be embodied in many different forms and should not be construed as limited to the exemplary embodiments set forth herein. All materials (e.g., solids, liquids, gases, or combinations thereof) may flow through conduits (e.g., pipes and/or manifolds) unless specified otherwise or made clear from the context.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

As used herein, unless otherwise specified or made clear from the context, metals may include alkali metals (Li, Na, etc.), alkaline earth metals (Mg, Ca, etc.), transition metals (Fe, Ni, Co, etc.), and/or post-transition metals (Al, Ge, etc.). In a respective valence state of zero of each of these elements, the respective element is in a metallic state. In a valence state greater than zero, the respective element is in an oxidized state. Most metals spontaneously oxidize to a respective oxidized state in the presence of oxygen. Therefore, metals are frequently found in an oxidized state, and must be reduced to a zero-valence state to provide the electrical conductivity, ductility, etc. for which metals are useful. This reduction process may be accomplished electrochemically in a process known as electrowinning.

There are different techniques by which a supply of metal may be received into the plant. For example, metal may be delivered to an electrowinning plant by rail car or by truck. The metal may include metal in the form of metal ore. Metal ore is mined, then may go through one or more purification processes such as grinding, density (gravity) separation, roasting, magnetic separation, leaching (dissolution), precipitation, flocculation, and/or solvent extraction prior to loading into an electrochemical cell. Further, or instead, the metal received into the plant may include impure metal for electrorefining. For example, copper may go through a first electrowinning process to yield low-purity metallic copper, which may be loaded into a second electrowinning process in which the low-purity metallic copper is oxidized at the positive electrode, goes into the electrolyte, and travels to the negative electrode where copper deposits as high-pure copper. The impure metal may be scrap metal in some instances. As a specific example, the scrap metal may be from a recycling process (e.g., zinc oxide recovered during the recycling of galvanized steel).

Electricity may be delivered to the electrowinning plant by a power network. The power network may include, for example, a grid that connects dozens of power plants to millions of customers over distances of tens to hundreds of miles. Additionally, or alternatively, the power network may include a local micro-grid that supplies power from a few power generators to a few loads.

As used herein, unless otherwise specified or made clear from the context, the term “negative electrode” is intended to include materials which contribute to the function of the electrode upon which metal reduction occurs during charge, and upon which metal oxidation occurs during discharge. As such, unless otherwise specified or made clear from the context, the term “negative electrode” as used herein shall be understood to be inclusive of a current collector for transporting electrons and reactant materials immediately adjacent to the current collector. The current collector is sometimes called the “cathode blank.” The current collector may include a “starter” deposit of the metal of interest. The reactant materials may include oxidized metal dissolved in the electrolyte, or solid particles of oxidized metal suspended in an electrolyte slurry, or solid particles of oxidized metal contained within a chamber mechanically coupled to the current collector.

Also, as used herein, the term “electrical communication” in reference to electrodes of an electrochemical cell shall be understood to refer to electrical communication along a completed electrical circuit including an electrolyte of the electrochemical circuit (ionic communication), unless otherwise specified or made clear from the context. Thus, for example, with a switch in an open position to interrupt an electrical circuit including an electrode at least partially submerged in an electrolyte, the interruption of the electric circuit including the electrode shall be understood to electrically isolate the electrode from any one or more other electrodes that may also be at least partially submerged in the electrolyte. As another example, removing an electrode from the electrolyte shall be understood to electrically isolate the electrode from any one or more other electrodes that may remain at least partially submerged in the electrolyte. Further, or instead, a shield of inert and impermeable material may be selectively positioned in the electrolyte to electrically isolate an electrode from one or more other electrodes at least partially submerged in the electrolyte.

For the sake of clear and efficient description, elements with numbers having the same last two digits in the disclosure that follows shall be understood to be analogous to or interchangeable with one another, unless otherwise explicitly stated or made clear from the context and, therefore, are not described separately from one another, except to note difference or to emphasize certain features. Thus, for example, an electrochemical cell 106 and electrochemical cells 306, 406, 506, 606a, 606b, and 706 shall be understood to be analogous to or interchangeable with one another, unless otherwise specified or made clear from the context. Further, in the schematic representations of various feedstocks described herein, only a few particles are shown for the sake of clarity of depiction and it shall be appreciated that feedstock used to form any one or more of the iron electrodes described herein may include many more instances of particles than those shown in the figures.

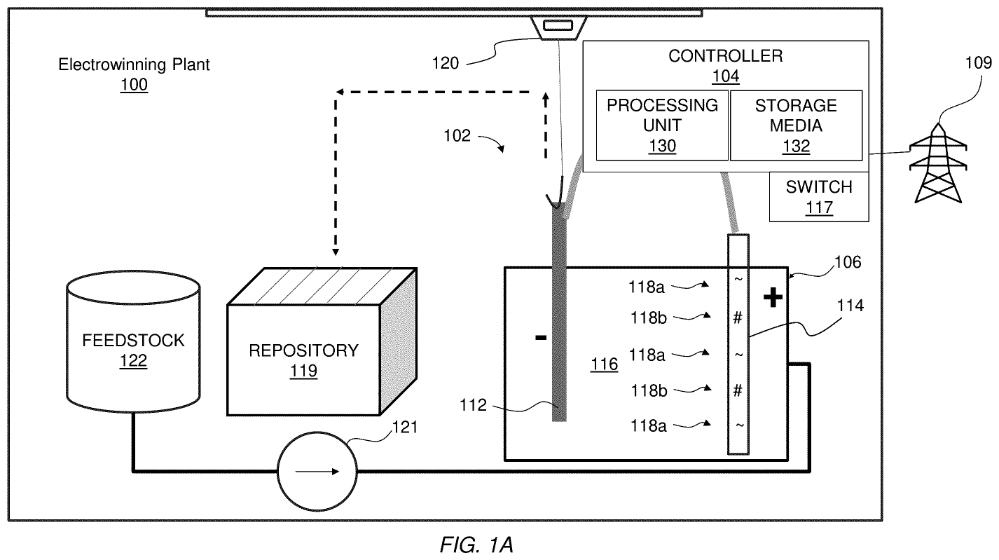

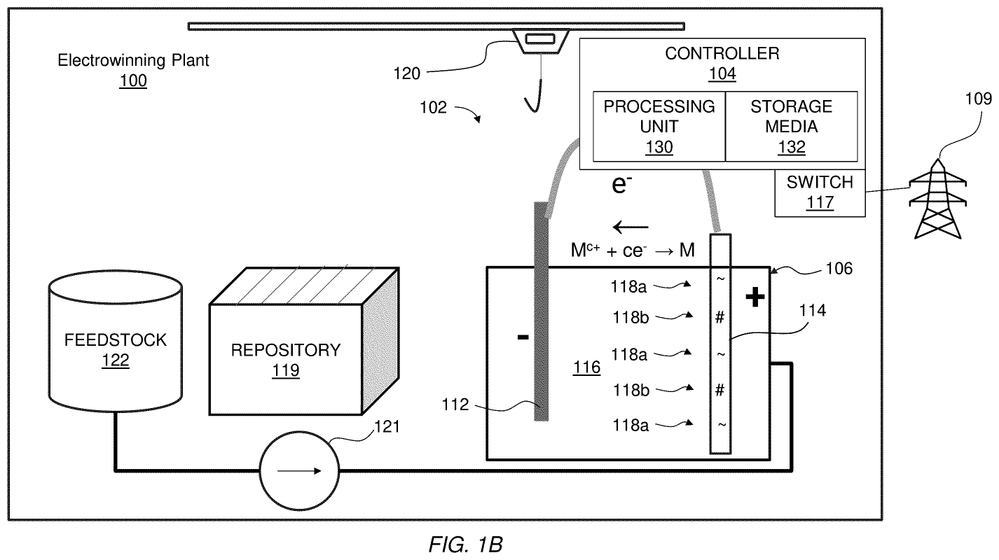

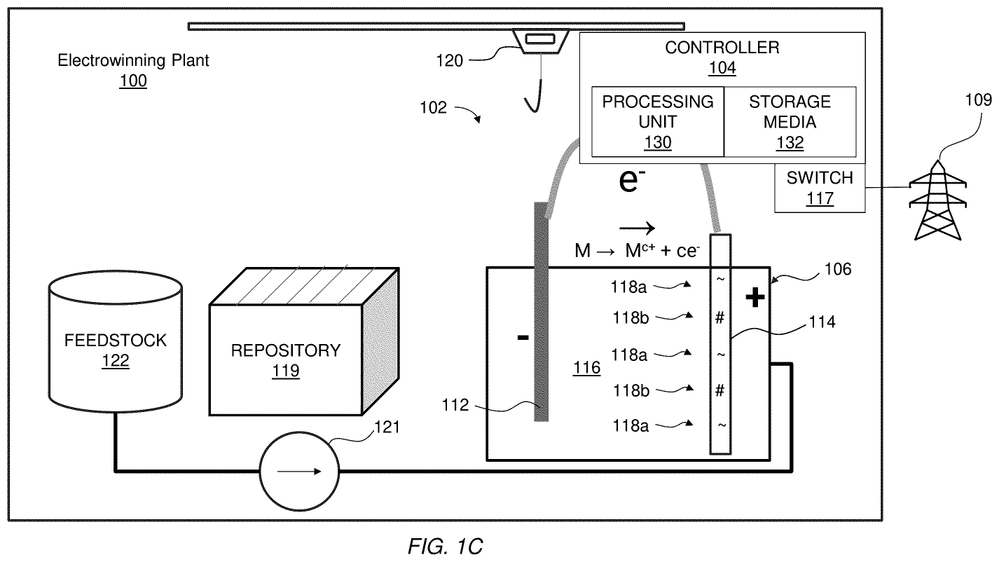

Referring now to FIGS. 1A-1C, an electrowinning plant 100 may receive material (e.g., metallic metal, metal ore, scrap metal, or a combination thereof) in any appropriate manner (e.g., trucks, rail car or other vehicle) for safely and cost-effectively delivers metal in an oxidized state to the electrowinning plant 100, and the electrowinning plant 100 may also deliver metal in a zero valance state in the same manner. As compared to an electrowinning plant 100 with separate equipment for charging and discharging, If the source of the material includes impure metallic metal, the electrowinning plant 702 may be operated as an electrorefining plant, for example, copper electrorefining. If the source is metal ore or scrap metal, the electrowinning plant 100 may be operated as an electrowinning plant. For the sake of clear and efficient operation, it shall be appreciated that the electrowinning plant 100 is intended to encompass both electrorefining and electrowinning unless otherwise specified or made clear from the context.

The electrowinning plant 100 may include a system 102 for bidirectional operational control of the electrowinning plant 100, with the system 102 including a controller 104 in electrical communication with at least one instance of an electrochemical cell 106 (hereinafter referred to as “the electrochemical cell 106” for the sake of clear and efficient description). As described in greater detail below, the controller 104 may operate the electrochemical cell 106 in a charge mode or in a discharge mode. In the charge mode, metal in an oxidized state may be received into the electrochemical cell 106, and the electrochemical cell 106 may use electricity from a grid 109 to reduce the metal from the oxidized state to a zero valence state with a first electric current applied across electrodes of the electrochemical cell 106. In some instances, the metal in the zero valence state may be harvested from the electrochemical cell 106 for storage, where the metal in the zero valence state may be stored and/or processed for end-use in a different application (e.g., for fabrication of a metal electrode of a metal-air battery) or for use in the discharge mode in the electrochemical cell 106 to produce electricity according to any one or more of the various different techniques described herein. Specifically, in the discharge mode, the electrochemical cell 106 may oxidize at least some of the metal from the zero valence state to the oxidized state to generate a second electric current, oppositely charged relative to the first electric current, to generate electricity (e.g., for delivery to a grid 109). Thus, for example, metal in the zero valence state may be moved into the electrochemical cell 106 to produce electricity for as long as the controller 104 commands or until a supply of the metal in the zero valence state is depleted, whichever occurs first.

In use, as also described in greater detail below, the controller 104 may selectively switch operation of the electrochemical cell 106 between the charge mode and the discharge mode based on, for example, availability/cost of electricity from the grid 109. Thus, as compared to an electrowinning plant operable only to produce metal ore into product metal in the zero valence state, selectively switching operation of the electrochemical cell 106 according to the various different techniques described herein may facilitate achieving robust cost-effectiveness and profitability through volatile swings that may occur in metal and/or electricity markets in various geographic regions. Further, the electrowinning plant 100 may operate in charge mode for most of the year or for other long periods of time, producing the product metal, and may only operate in discharge mode for a total of between 100 and 1000 hours per year. However, even with such limited use of the discharge mode, the reversible operation of the system 102 for operational control of the electrowinning plant 100 may facilitate achieving rapid recoupment of capital expenses via cost savings associated with the switching techniques described herein. For example, determining to switch the electrochemical cell 106 from the charge mode to the discharge mode can include, determining that a price of electricity has risen above a threshold price, determining that the price of metal has fallen below a threshold price, or determining that a combination of the price of electricity and the price of metal indicates switching to discharge mode. In some cases, determining to switch from charge mode to discharge mode includes using a forecast of electricity prices; for example, an electricity price can be forecasted using a weather forecast, e.g., where high temperatures correlate to high energy usage and resulting high electricity prices.

In general, the electrochemical cell 106 may include a negative electrode 112, at least one instances of a positive electrode 114 (hereinafter referred to as “the positive electrode 114” for the sake of clear and efficient description), and an electrolyte 116 in fluid communication between the positive electrode 114 and the negative electrode 112. Unless otherwise specified or made clear from the context, the negative electrode 112 and the positive electrode 114 may have any appropriate dimensions (e.g., approximately 1 m tall and 1 m wide) for supporting throughput requirements of the electrowinning plant 100 operating in charge mode and/or for supporting electricity requirements of the electrowinning plant operating in the discharge mode.

The electrochemical cell 106 may be operable in the charge mode with a first electric current applied across the negative electrode 112 and the positive electrode 114, via the electrolyte 116 therebetween and with the negative electrode 112 including the metal in the oxidized state. Specifically, during charge, the reactions in the electrochemical cell 106 are:

cathode: Mⁿ⁺+ne⁻→M

anode: 2H₂O→O₂+4H⁺+4e⁻

During discharge, these reactions happen in the opposite direction. In some implementations, the reaction that occurs at the positive electrode 114 may include consumption of a gaseous species. For example, during charge, the reaction at the positive electrode 114 may include oxidation of hydrogen,

H₂→2H⁺+2e⁻

or oxidation of chlorine

2Cl⁻→Cl₂+2e⁻

During discharge, the reaction at the positive electrode 114 may include reduction of oxygen,

O₂+4H⁺+4e⁻→2H₂O

During charge operation, electricity may be delivered from the grid 109 to the electrochemical cell 106 via one or more switches 117 such that metal in the zero valence state may be deposited at the negative electrode 112. For the sake of clear and efficient description, the one or more switches 117 shall be understood to include any one or more of various different types of switches and/or power conditioning equipment as may be useful for converting power from the grid 109 for use in the electrochemical cell 106 and/or for converting power from the electrochemical cell 106 for delivery to the grid 109. The deposition time may range from, for example, 1 to 30 days or any appropriate amount of time. The deposition time may depend on the metal, the applied current, and risk of dendritic deposition. After a period, the metal in the zero valence state may be harvested and placed into a repository 119 of the electrowinning plant 100. The repository 119 may be a storage area for storing product metal plates (e.g., prior to packaging and/or for use in the electrochemical cell 106 operating in the discharge mode). In some instances, harvesting the metal in the zero valence state may include removing the negative electrode 112 from the electrochemical cell 106 using a crane 120 of the electrowinning plant 100. In other instances, harvesting the metal in the zero valence state may include sliding the negative electrode 112 out of the bottom of the electrochemical cell 106 under force of gravity and through a rinse station. Further, or instead, harvesting may include performing optional processes for cleaning and/or flattening a current collector of the negative electrode 112 prior to returning the negative electrode 112 to the electrochemical cell 106 for operation in another round of charge operation of the electrochemical cell 106.

In the discharge mode, the electrochemical cell 106 may be operable with the second electric current, oppositely charged with respect to the first electric current, generated across the negative electrode 112 and the positive electrode 114, via the electrolyte 116 therebetween and with the negative electrode 108 including metal in the zero valence state to produce electricity that may be conditioned and delivered to the grid 109 via the one or more switches 117 in electrical communication between the electrochemical cell 106 and the grid 109. As electricity is produced, the metal in the zero valence state at the negative electrode 108 becomes metal in the oxidized state until no more electricity is produced by electrochemical cell 106. Thus, to recharge the electrochemical cell 106 mechanically, the negative electrode 108 may be removed from the electrochemical cell 106 according to any one or more of the various different techniques described herein, such as through the use of the crane 120 to move the negative electrode 112 to the repository 119 or another storage area, where the metal in the oxide state may be processed (e.g., dissolved in the electrolyte 110) for use in a subsequent charge mode operation of the electrochemical cell 106.

In certain implementations the instance of the positive electrode 114 may be used for both charge and discharge reactions. For example, the positive electrode 114 may include a flow field comprising channels and ribs to guide the flow of the gaseous reaction, a gas diffusion layer to deliver the gas from the flow channels to the catalyst layer, and catalyst layer where gas in gas-filled hydrophobic pores reacts with ions in the electrolyte at a triple-phase boundary between the gas, electrolyte 110, and electrically conductive support. For example, during charge mode, hydrogen gas may flow through the flow field. When the mode is switched from charge to discharge, a motor may power a blower to flush the hydrogen from the field. During discharge, the blower may flow air through the flow field.

As an example, the positive electrode 114 may be a bifunctional oxygen electrode in electrical communication with the negative electrode 108 in each of the charge mode and the discharge mode. A bifunctional oxygen electrode is an electrode on which oxygen reduction may occur in discharge mode and oxygen evolution may occur in charge mode. The bifunctional oxygen electrode is comprised of materials that are electrochemically durable at both the potential of oxygen reduction and the potential of oxygen evolution. For example, the positive electrode 114 may define hydrophobic pores 118a and hydrophilic pores 118b. The hydrophobic pores 118a may repel water while allowing gas (e.g., oxygen) to pass through the hydrophobic pores 118a. This may facilitate the diffusion of oxygen molecules toward catalyst sites within the hydrophobic pores 118a. The catalyst at the catalyst sites within the hydrophobic pores 118a may include Pt, IrO₂, alloys of Pt, MnO₂, or a combination thereof. The electrically conductive support may include high-surface-area carbon or nickel. The catalyst layer may include a hydrophobic polymer to maintain gas pores. The ribs of the flow field may include carbon, graphite, carbon or graphite composite with a polymer, metal, or metal coated with a conductive, corrosion-resistance coating. Further, or instead, the hydrophilic pores 118b may attract and retain the electrolyte 116. This may increase the likelihood of a supply of ions (protons and hydroxide depending on the reaction) near the catalyst for efficient oxygen reactions. The placement of the hydrophobic pores 118a and the hydrophilic pores 118b and/or the ratio of the hydrophobic pores 118a to the hydrophilic pores 118b may be varied depending on target rates of desired reactions for a specific end-use application of the electrochemical cell 106. Methods of fabricating the positive electrode 114 may include fabricating a microporous metal with controlled porosity and surface energy, such that some pores may be hydrophobic and filled with gas flowable to a gas flow field and other pores may be hydrophilic and filled with electrolyte.

In some examples, the positive electrode 114 may include one or more active layers and one or more conductive backing layers. An active layer may include nickel, Raney nickel, nickel oxide, lithium impregnated nickel oxide, nickel hydroxide, nickel oxyhydroxide, titanium, titanium dioxide, or a combination thereof. In some instances, the active layer may further, or instead, include platinum, iridium oxide, silver, perovskites, spinel, or a combination thereof. In some implementations, the active layer may include PTFE, PFA, FEP, PVdF, polyethylene, HDPE, LDPE, UHMWPE, polypropylene, or a combination thereof. Further, or instead, the active layer may include two or more distinct layers with different porosities. In some implementations, the conductive backing layer may include nickel, Raney nickel, nickel oxide, lithium impregnated nickel oxide, nickel hydroxide, nickel oxyhydroxide, titanium, titanium dioxide, or a combination thereof. In some implementations, the conductive backing layer may include PTFE, PFA, FEP, PVdF, polyethylene, HDPE, LDPE, UHMWPE, polypropylene, or a combination thereof. Further, or instead, the active layer may include two or more distinct layers with different porosities.

In general, the metal in the oxidized state may be receivable into the electrochemical cell 106 according to any one or more of various different techniques compatible with the metal in the oxidized state and the electrochemical cell 106. For example, the system 102 may include a pump 121 operable to move metal in the oxidized state from a feedstock 128 of the electrowinning plant 100 and into the electrochemical cell 106. That is, in the feedstock 128, the metal in the oxidized state may be dissolved in a carrier medium (e.g., dissolved in the electrolyte 116) such that the feedstock 128 is flowable. Further, or instead, the feedstock 128 may be formed using any one or more of various different purification techniques, such as grinding, gravity separation, roasting, leaching (dissolving), solvent extraction, or combinations thereof. For example, the feedstock 128 may be formed in a leaching tank or pond for dissolving the ore in acid to make electrolyte containing metal in the oxidized state. Pumped solutions may be used in electrowinning of Ni, Zn, Co, and Cu. Further, or instead, the feedstock 128 may include ore particles mixed with alkaline electrolyte to form a slurry of solid ore particles suspended in liquid electrolyte solution, then pumping the slurry to the electrochemical cell 106. The pump 121 may be operable to pump the metal in the oxidized state from the feedstock 128 into the negative electrode 112 for charge mode operation of the electrochemical cell 106. The pump 121 may include any type of pumping system compatible with the specific metal oxide being pumped, the concentration and form of the metal oxide, and the flow rate and pressure specified for the application. For example, the pump 121 may include a centrifugal pump, a diaphragm pump, a gear pump, a screw pump, or a combination thereof. While metal in the oxidized state may be pumped into the electrochemical cell 106, it shall be appreciated that other techniques are additionally or alternatively possible for introducing metal in the oxidized state into the electrochemical cell 106. For example, the negative electrode 112 may be a pocket electrode and the metal in the oxidized state may be filled with ore particles.

In some instances, a constant flowrate of the electrolyte 116 may be maintained into the electrochemical cell 106. The constant flowrate of the electrolyte 116 into the electrochemical cell 106 may, in turn, maintain the concentration of metal ions across the surface of the cathodes, which facilitates high current. After exiting the electrochemical cell 106, the electrolyte 116 may be combined with the outlet of the leaching or solvent extraction processes and then may be recirculated back into the electrochemical cell 106.

In general, the electrolyte 116 may be any one or more of various different materials compatible with the oxidation and reduction reactions of the target metal in the zero valence state formed in the charge mode and consumed in the discharge mode. For example, in electrowinning of copper, the electrolyte 116 may include sulfuric acid and copper sulfate. The sulfuric acid concentration may be about 0.5 to 3 M. The copper concentration may be about 0.1 to 1 M. Likewise, in the electrowinning of zinc, the electrolyte 116 may include sulfuric acid and zinc sulfate. The sulfuric acid concentration may be about 0.5 to 3 M. The zinc concentration may be about 0.1 to 1 M.

In general, the negative electrode 112 may include a current collector and adhered deposited metal. Harvesting the deposited metal from the negative electrode 112 may include lifting the negative electrode 112 out of the electrolyte 116 of the electrochemical cell 106, carrying the negative electrode 112 to a rinse station, rinsing the negative electrode 112 to remove any remaining amounts of the electrolyte 116, stripping the deposited metal off the current collector, packaging the product metal for delivery to customers, and returning the negative electrode 112 (e.g., the current collector) to the electrolyte 116 of the electrochemical cell 106. In some implementations, the negative electrode 112 may include a pocket defining a chamber containing the product metal produced during charge mode of the electrochemical cell 106. In such implementations, the negative electrode 112 may be lifted out of the electrochemical cell 106, the pocket opened, and the product metal removed from the chamber.

In general, the controller 104 may a processing unit 130 and non-transitory computer-readable storage media 132 in electrical communication with one another. The processing unit 130 may be in electrical communication with the electrochemical cell 106 and, in some instances, with the crane 120 and/or the pump 121. The non-transitory computer-readable storage media 132 may have stored thereon instructions for causing the processing unit 130 to carry out any one or more steps associated with operating the electrochemical plant according to the techniques described herein.

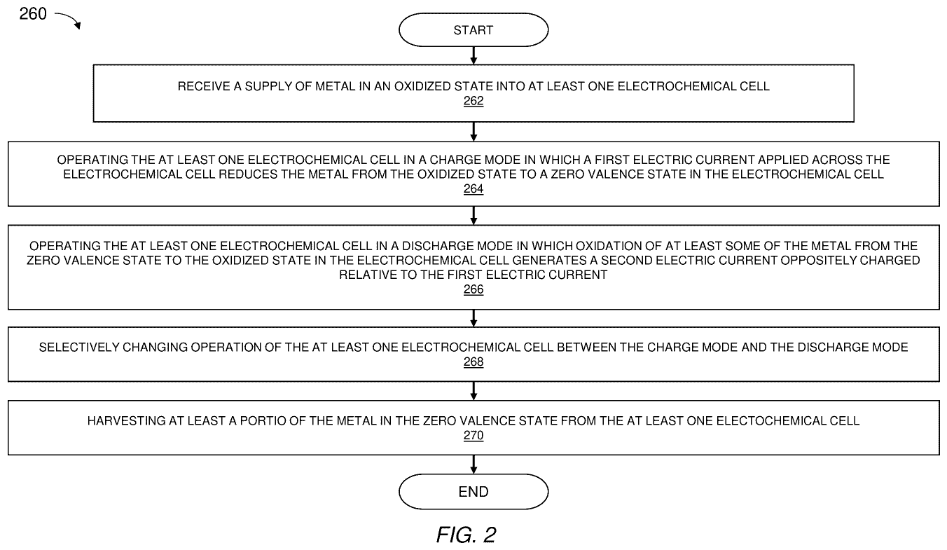

FIG. 2 is a flowchart of an exemplary method 260 of controlling bidirectional operation of an electrowinning plant. Unless otherwise specified or made clear from the context, it shall be understood that any one or more of various different aspects of the exemplary method 260 may be carried out by the controller 104 (FIGS. 1A-IC) in electrical communication with one or more instances of the electrochemical cell 106 (FIGS. 1A-IC), the crane 120 (FIGS. 1A-IC), and the pump 121 (FIGS. 1A-IC). For example, the non-transitory computer-readable storage media 132 (FIGS. 1A-IC) may have stored thereon instructions for causing the processing unit 130 (FIGS. 1A-IC) to carry out one or more aspects of the exemplary method 260.

As shown in step 262, the exemplary method 260 may include receiving a supply of metal in an oxidized state into at least one electrochemical cell. The metal may include one or more of iron, copper, zinc, nickel, manganese, lead, aluminum, or cobalt. Further or instead, the metal in the oxidized state may include metal ore. In certain implementations, receiving the supply of metal in the oxidized state into the at least one electrochemical cell may include dissolving the metal in the oxidized state in a solution with the electrolyte and pumping the solution into the at least one electrochemical cell. Further, or instead, receiving the supply of metal in the oxidized state into the at least one electrochemical cell may include providing a solid form of metal ore to the negative electrode of the at least one electrochemical cell.

As shown in step 264, the exemplary method 260 may include operating the at least one electrochemical cell in a charge mode in which a first electric current applied across the electrochemical cell reduces the metal from the oxidized state to a zero valence state in the electrochemical cell. For example, In certain implementations, the metal in the oxidized state may be included in the negative electrode of the electrochemical cell. In certain instances, operating the at least one electrochemical cell in the charge mode may include receiving power from a power network to apply the first electric current across the electrochemical cell, and operating the at least one electrochemical cell in the discharge mode includes delivering, to the power network, at least some of the power generated by the electrochemical cell. The power network may be an electrical grid, such as a bulk grid or a micro-grid.

While the at least one electrochemical cell may include a single instance of the electrochemical cell in some instances, it shall be appreciated that the at least one electrochemical cell may include a plurality of electrochemical cells in some instances. In such implementations, operating the at least one electrochemical cell in the charge mode may include operating a first one of the plurality of electrochemical cells in the charge mode, and operating the at least one electrochemical cell in the discharge mode may include operating a second one of the plurality of electrochemical cells in the discharge mode. Continuing with this example, selectively changing operation of the at least one electrochemical cell between the charge mode and the discharge mode may include controlling electrical communication between a power network and the first one and the second one of the plurality of electrochemical cells.

As shown in step 266, the exemplary method 260 may include operating the at least one electrochemical cell in a discharge mode in which oxidation of at least some of the metal from the zero valence state to the oxidized state in the electrochemical cell generates a second electric current oppositely charged relative to the first electric current. For example, operating the at least one electrochemical cell in the discharge mode may include generating the second electric current across the negative electrode and the at least one positive electrode, via the electrolyte therebetween, with the negative electrode including metal in the zero valence state. Further, or instead, operating the at least one electrochemical cell in the discharge mode may include inserting an additional amount of the metal in the zero valence state into the electrochemical cell such that the electrochemical cell is mechanically recharged by the additional amount of the metal in the zero valence state.

In certain implementations, a gaseous molecule is flowable through a gas flow field adjacent to the positive electrode. For example, the gaseous molecule may include a first molecule as the electrochemical cell operates in the charge mode, and the gaseous molecule includes a second molecule as the electrochemical cell operated in the discharge mode. In some implementations, the first molecule and the second molecule may be the same. Further, or instead, the first molecule may include chlorine generated during charge. Additionally, or alternatively, the first molecule may include hydrogen generated during charge. Still further, or instead, the second molecule may include oxygen reduced during discharge.

As shown in step 268, the exemplary method 260 may include selectively changing operation of the at least one electrochemical cell between the charge mode and the discharge mode. The selective change in operation of the at least one electrochemical cell may be repeated (e.g., periodically) based on information received by a controller carrying out one or more aspects of the exemplary method 260.

During charge operation of the at least one electrochemical cell, an electrowinning plant may produce metal in the zero valence states and consume electricity. However, selectively switching operation of the at least one electrochemical cell may include switching from the at least one electrochemical cell from the charge operation to the discharge operation during, for example, times when electricity is in high demand. The decision of selectively switching the at least one electrochemical cell between the charge mode to produce metal in the zero valence state and the discharge mode to produce electricity may be based on any one or more of several factors. For example, the electrowinning plant must fulfill obligations for delivery of metal product to customers.

Markets for both metal in the zero valence state (product metal) and electricity are highly volatile. Metal prices may be affected by demand for metal, which may vary over time as needs for construction materials change. Further, or instead, Metal prices may be affected by supply from competing electrowinning and/or smelting operations which, in turn, may be affected by geopolitical factors. Electricity markets may vary, for example, with time of day, season of the year, and weather conditions. Electricity demand may be generally high on hot days, particularly in the afternoon, when air conditioning use is high. Electricity prices may be high in winter, when fuel is used for heating. During extremely hot or extremely cold weather, electricity prices may spike to values more than 100 times that of the baseload value. In extreme situations, the demand on the electricity grid may cause blackouts. Therefore, grid utilities may offer capacity payments to factories. That is, the grid utility may pay the factory a fixed amount of money each month, in return for the factory committing to reducing consumption during times of high electricity prices. Some electrowinning plants may reduce their production rate, and thus their electricity consumption, during hot afternoons.

In certain implementations, selectively changing operation of the at least one electrochemical cell may include operating the at least one electrochemical cell in discharge mode during times when the revenue from producing electricity is high. For example, the at least one electrochemical cell may be operable in discharge mode when the revenue that the at least one electrochemical cell may earn from electricity is higher than the cost of labor and operations for operating the at least one electrochemical cell in discharge mode to produce product metal—namely, metal in the zero valence state. The electricity price at which the at least one electrochemical cell is selectively switched to operate in discharge mode may depend on the market for the product metal producible by the at least one electrochemical cell operating in the charge mode.

Because electricity prices are highly correlated with weather, the probability of high electricity prices may be forecasted with high accuracy multiple days in advance. Based on such forecasting days in advance, selectively switching operation of the at least one electrochemical cell between charge mode and discharge mode may include preparing product inventory of the electrowinning plant and preparing operations for a switch from charge mode to discharge mode.

In some instances, selectively switching operation of the one or more electrochemical cells may include receiving cost information. This may include, for example, the cost of electricity, the price of metal produced by the electrowinning plant, and the cost of production of metal produced by the electrowinning plant.

Further, or instead, selectively switching operation of the at least one electrochemical cell may include determining a cost of continuing to operate the at least one electrochemical cell to produce metal in the zero valence state and determining a cost of switching the at least one electrochemical cell to discharge mode and operating the at least one electrochemical cell as a power producer. Determining the cost of operating the at least one electrochemical cell in charge mode to produce metal in the zero valence state may include determining the cost of electricity and material consumed, determining the revenue from metal sold and taking the difference of those values. Further, or instead, determining the cost of operating the at least one electrochemical cell as a power producer may include determining the cost of the metal consumed and the revenue from the power sold and taking the difference of those values.

In some implementations, selectively switching the at least one electrochemical cell between the charge mode and the discharge mode may include determining whether the at least one electrochemical cell will generate more revenue if it continues to operate in charge mode to produce metal in the zero valence state or if it will generate more revenue if the at least one electrochemical sell is switched to a discharge mode to operate as a power producer. If operating the at least one electrochemical cell in charge mode generates more revenue, the at least one electrochemical cell may continue to operate in charge mode. If operating the at least one electrochemical cell in a discharge mode to produce power as a power producer generates more revenue, the at least one electrochemical cell may be switched to operate in discharge mode.

In some instances, selectively switching operation of the at least one electrochemical cell may include providing an indication to a plant operator (e.g., on a graphical user interface) that switching to discharge mode will generate greater revenue. As an example, selectively switching operation of the at least one electrochemical cell may include receiving an input from the plant operator to proceed with the switch.

In certain implementations, selectively changing operation of the at least one electrochemical cell between the charge mode and the discharge mode may include operating the at least one electrochemical cell in the discharge mode for greater than about 1 percent and less than about 13 percent of time that the at least one electrochemical cell is in the charge mode. Further, or instead, selectively changing operation of the at least one electrochemical cell between the charge mode and the discharge mode may include operating the at least one electrochemical cell in the charge mode for about 1 day to about 30 days between harvesting.

In some implementations, selectively changing operation of the at least one electrochemical cell may be based on a parameter associated with operation of the at least one electrochemical cell compared to a predetermined target value of the parameter. For example, the parameter associated with operation of the at least one electrochemical cell may be cost associated with applying the first electric current across the at least one electrochemical cell to operate the at least one electrochemical cell in the charge mode.

As shown in step 270, the exemplary method 260 may additionally or alternatively include harvesting at least a portion of the metal in the zero valence state from the at least one electrochemical cell.

Having described certain aspects of systems and methods of controlling bidirectional operation of electrowinning plants, additional or alternative aspects of these systems and methods are now described.

For example, while systems of controlling bidirectional operation of electrowinning plants have been described as including positive electrode that is a bifunctional oxygen electrode, other arrangements of using two separate positive electrodes are described in the paragraphs that follow.

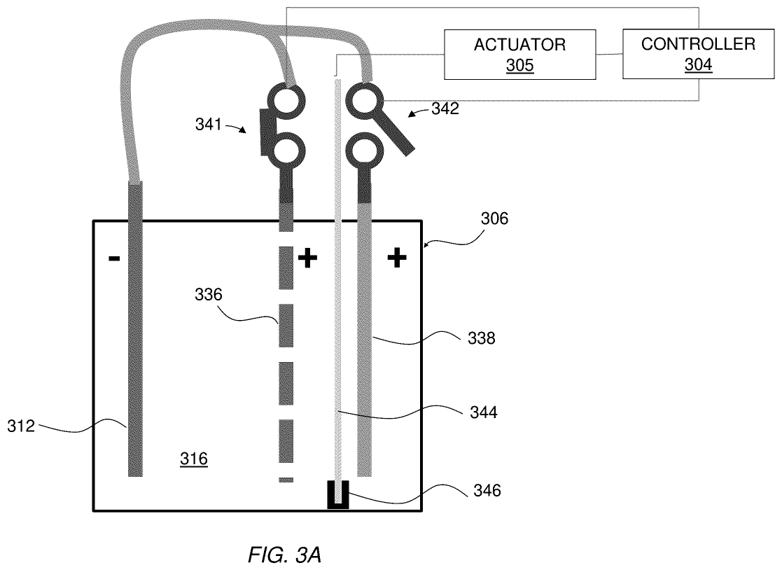

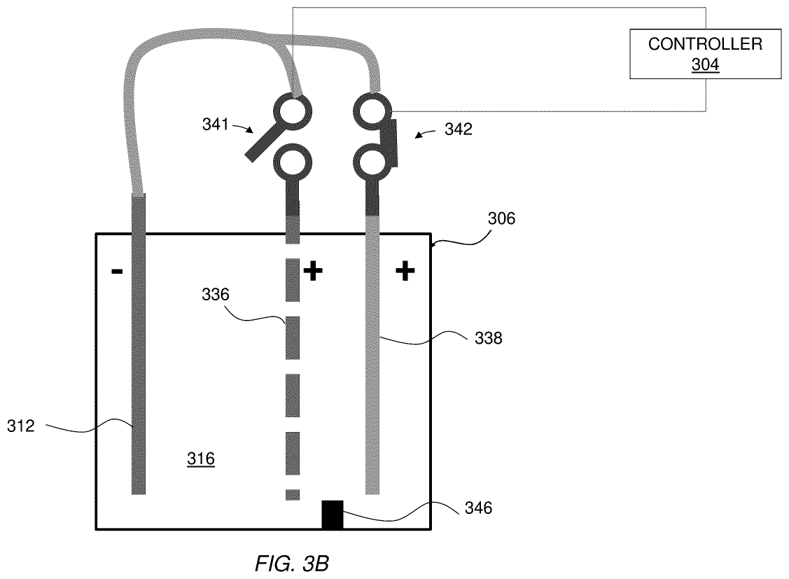

Referring now to FIGS. 3A-3B, an electrochemical cell 306 may include a negative electrode 312, an electrolyte 316, and two positive electrodes—namely, a charge positive electrode 336 for electrowinning and a discharge positive electrode 338 for producing electric power. The charge positive electrode 336 may be used in a charge mode of the electrochemical cell 306, and the discharge positive electrode 338 may be used in a discharge mode of the electrochemical cell 306. For example, the electrochemical cell 306 may include a first switch 341 and a second switch 342. The first switch 341 may be coupled to the charge positive electrode 336, and the second switch 342 may be coupled to the discharge positive electrode 338. Both the first switch 341 and the second switch 342 may be coupled to the negative electrode 312. Further, or instead the electrochemical cell 306 may also be connected to a busbar that is connected to other instances of the electrochemical cell 306.

In general, the first switch 341 and the second switch 342 may each be in electrical communication with a controller 304 operable to actuate the first switch 341 and the second switch 342 in coordination with one another for selectively coupling the charge positive electrode 336 and the discharge positive electrode 338 to the negative electrode 312 to complete an electrical circuit.

In some implementations, the charge positive electrode 336 may remain in the electrolyte 316 during operation of the electrochemical cell 306 in the discharge mode. In such implementations, the charge positive electrode 336 may be porous to facilitate electrical communication of the electrolyte 316 between the negative electrode 312 and the discharge positive electrode 338. In such implementations, the porosity of the charge positive electrode 336 may be 20% to 95%. For example, the charge positive electrode 336 may include a mesh, screen, foam, and/or expanded metal.

The discharge positive electrode 338 may include a conductive gas diffusion electrode catalyst, such as carbon, manganese oxide, silver, platinum, nickel foam, a nickel mesh, or the like, and may also include a hydrophobic material, such as polytetrafluoroethylene (PTFE), for example. In some examples, the discharge positive electrode 338 may be a gas diffusion electrode. In those cases, the gas diffusion may include any one or more of the features described in U.S. Pat. App. Pub. 2013/0115526, entitled “AIR CATHODE WITH GRAPHITE BONDING/BARRIER LAYER,” the entire contents of which are hereby incorporated herein by reference.

In some instances, the charge positive electrode 336 may be formed of a nickel mesh or a nickel-plated steel mesh. Further, or instead, the charge positive electrode 336 may include an oxygen evolution reaction catalyst (e.g., nickel, alloys of nickel with iron, manganese oxide, iron, nickel oxide (NiOx), nickel oxyhydroxide (NiOₓ(OH)_{y}, iron oxide (FeOₓ), iron oxyhydroxide (FeOₓ(OH)_{y}).

The electrolyte 316 may include an aqueous solution. The aqueous solution may be acidic and, further, or instead, may include sulfate, phosphate, or chloride anions. The aqueous solution may be basic and, further, or instead, may include alkali metal cations such as Na, K, or Li. The negative electrode 312, the charge positive electrode 336, and the discharge positive electrode 338 may be oriented vertically, horizontally, or tilted at an angle.

The discharge positive electrode 338 may degrade over time when in electrical communication with the electrolyte 316. For example, because ores contain many impurities, the electrolyte 316 may contain impurities containing elements such as Ca, Mg, Mn, Fe, Cl, and F, which may poison and/or foul the catalyst on the discharge positive electrode 338 over time.

Additionally, or alternatively, the electrolyte 316 may include additives (e.g., gelatine or gum arabic), which facilitate smooth deposition at the negative electrode 312. Such additives may include licorice, soybean extract, or sodium silicate to suppress acid mist. These additives may poison or foul the catalyst on the discharge positive electrode 338. Additionally, or alternatively, these additives may cause gas-filled pores of the discharge positive electrode 338 to lose hydrophobicity, resulting in electrolyte flooding of the discharge positive electrode 338. The rate of degradation of the discharge positive electrode 338 may be reduced by reducing the amount of time that the discharge positive electrode 310 spends in electrical communication with the electrolyte 316.

To reduce the rate of degradation of the charge positive electrode 336 and the discharge positive electrode 338, each of these electrodes may be electrically disconnected from the electrical circuit when not in use.

Referring now to FIG. 3A, the electrochemical cell 306 is in a charge mode in which the first switch 341 is closed and coupling the charge positive electrode 336 to the negative electrode 312 and the second switch 342 is open and disconnecting the discharge positive electrode 338 from the circuit. Disconnecting the discharge positive electrode 338 from the circuit can be useful, for example, to reduce the rate of degradation of the discharge positive electrode 338.

Referring now to FIG. 3B, the electrochemical cell 306 is shown in a discharge mode in which the first switch 341 is open and disconnecting the charge positive electrode 336 from the circuit and the second switch 342 is closed and coupling the discharge positive electrode 338 to the negative electrode 312. Disconnecting the charge positive electrode 336 from the circuit can be useful, for example, for reducing the rate of degradation of the charge positive electrode 336.

Referring again to FIGS. 3A-3B, in some examples, there may be separation between the charge positive electrode 336 and the discharge positive electrode 338. The separation may be at least partially filled with the electrolyte 316. The separation may include stand-offs and/or a microporous separator and/or an insulating mesh to reduce the likelihood of electrical contact between the charge positive electrode 336 and the discharge positive electrode 338.

The charge positive electrode 336 may include a catalyst, such as a catalyst for oxygen evolution. In such cases, the catalyst may become reduced if the charge positive electrode 336 is electrically connected to the discharge positive electrode 338 during discharge mode. That is, there may be some reduction of the catalyst at discharge potentials. Such reduction may lead to an increase in electrochemical resistance during an initial transient of the next charge mode operation. The effect may be transient as the catalyst is oxidized back to its catalytic state during charging.

Additionally, or alternatively, the discharge positive electrode 338 may be rinsed by flowing a solvent (e.g., water) through the flow field of the discharge positive electrode 338 after the completion of operation of the electrochemical cell 306 in the discharge mode. Rinsing the discharge positive electrode 338 may remove the electrolyte 316 and, thus, may reduce the likelihood of oxidative degradation.

In general, the controller 304 in electrical communication with at least one instance of an actuator 305 operable to move one or more portions of the electrochemical cell 306 to interrupt electrical communication between the discharge positive electrode 338 and the negative electrode 312 as the charge positive electrode 336 and the negative electrode 312 are in electrical communication with one another via the electrolyte 316 in charge mode operation of the electrochemical cell 306. In some examples, the electrochemical cell 306 may include a shield 344. Electrical communication between the discharge positive electrode 338 and the negative electrode 312 may be interrupted by actuating the at least one instance of the actuator 305 to position the shield 344 between the discharge positive electrode 338 and the charge positive electrode 336 in the electrolyte 316. The shield 344 may extend both vertically and laterally through the entire height and depth of the electrolyte 316 to completely fluidically isolate or nearly completely fluidically isolate (e.g., allowing for a small amount of fluid communication that does not result in measurable degradation of the discharge positive electrode 338) the discharge positive electrode 338 from the negative electrode 312 and the charge positive electrode 336 in the electrolyte 316.

The shield 344 may be electrically insulating and fluid impermeable. The shield 344 may prevent or at least reduce the likelihood of electrolyte transport to the discharge positive electrode 338, thus reducing the likelihood of degradation such as deposition or adsorption of impurities onto the surface of the discharge positive electrode 338. The shield 344 may also or instead prevent or reduce the likelihood of electrical contact between the discharge positive electrode 338 and the charge positive electrode 336. The shield 344 may extend the entire width of the electrochemical cell 306, as may be useful for blocking substantially all transport of the electrolyte 316 to the discharge positive electrode 338.

The shield 344 may be removable from the electrochemical cell 306 in some instances. For example, a crane or other lifting device may be used to lift the shield 344 from the electrolyte 316 of the electrochemical cell 306 to prepare the electrochemical cell 306 to operate in discharge mode. FIG. 3B illustrates the example scenario in which the shield 344 has been removed from the electrolyte 316 of the electrochemical cell 306.

The shield 344 may include frames or seals to reduce the likelihood of transport of electrolyte around the sides of the shield. For example, the electrochemical cell 306 may include a frame 346 immersed in the electrolyte 316 and sized to receive the shield 344. The frame 346 may have a U-shape with two sides and a gap between the two sides where the shield 344 may be inserted (e.g., slid into place). The frame 346 may facilitate sliding the shield 344 into and out of the electrolyte 316 of the electrochemical cell 306. The shield 344, the frame 346 or both may be made of a material that is inert in the electrolyte, impermeable, and electrically insulating, such as polyethylene, polypropylene, acrylic, or acrylonitrile butadiene styrene (ABS).

In some examples, when the shield 344 is in place, the discharge positive electrode 338 may be thermally isolated from the negative electrode 312 and the charge positive electrode 336. For example, the electrochemical cell 306 may achieve a degree of thermal isolation using vacuum insulation or thermal barriers, thermal switches, or an active cooling system such as a coolant circulation system that activates when the temperature exceeds a certain threshold.

In some examples, when the shield 344 is in place, the electrolyte 316 surrounding the discharge positive electrode 338 may be removed and/or an alternate solution introduced. For example, an inert or protective solution may be introduced to partially or completely surround the discharge positive electrode 338 when the shield 344 is in place. An example option is to use a non-conductive, inert liquid such as mineral oil or silicone oil. These substances do not support electrochemical reactions and can effectively isolate the discharge positive electrode 338 from any reactive species, thereby preventing or reducing the likelihood of degradation. Another possibility is to use an inert gas environment, such as nitrogen or argon. This can be achieved by sealing the discharge positive electrode 338 in a chamber filled with the inert gas, which eliminates the presence of oxygen, moisture, and other reactive gases that contribute to degradation.

As another example, while a discharge positive electrode may be fluidically isolated from a charge positive electrode in an electrolyte, other approaches to separation are additionally or alternatively possible.

Referring again to FIG. 2, selectively changing operation of the at least one electrochemical cell according to step 268 of the exemplary method 260 may include selective electrical isolation of the negative electrode from one of the charge positive electrode and the discharge positive electrode depending on the operation mode of the at least one electrochemical cell. For example, selective electrical isolation of the negative electrode from one of the charge positive electrode and the discharge positive electrode may include interrupting electrical communication between the discharge positive electrode and the negative electrode as the charge positive electrode and the negative electrode are in electrical communication with one another via an electric circuit including the electrolyte.

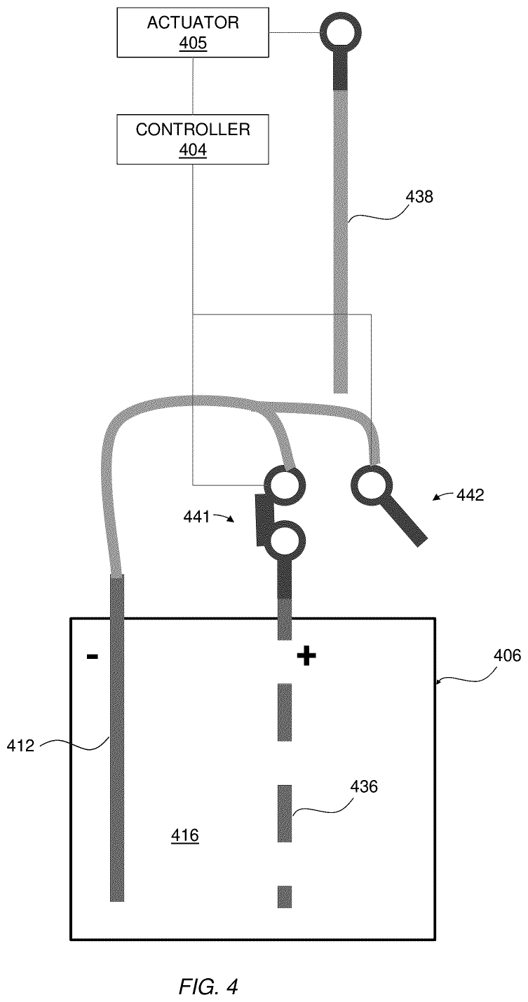

Referring now to FIG. 4, an electrochemical cell 406 may include a negative electrode 412, an electrolyte 416, a charge positive electrode 436, and a discharge positive electrode 438. The negative electrode 412 and the charge positive electrode 436 may each be at least partially immersed in the electrolyte 416 during charge and discharge operation of the electrochemical cell 406.

In general, a controller 404 may be electrical communication with at least one instance of an actuator 405, and the controller 404 may be operable to actuate the at least one instance of the actuator 405 to move the discharge positive electrode 438 in and out of the electrolyte 416. For example, the discharge positive electrode 438 may be lifted out of the electrolyte 416 when the electrochemical cell 406 is operating in the charge mode. With the discharge positive electrode 438 lifted out of the electrolyte 416, a first switch 441 may be closed to connect the charge positive electrode 436 to the circuit including the negative electrode 412 and the electrolyte 416. With the discharge positive electrode 438 out of the electrolyte 416, the discharge positive electrode 438 may be rinsed to reduce to likelihood of salt precipitating in pores of the discharge positive electrode 438.

The controller 404 may be operable to actuate the at least one instance of the actuator 405 to lower the discharge positive electrode 438 back into the electrolyte 416 when the electrochemical cell 406 is operating in the discharge mode, at which time the controller 404 may actuate a first switch 441 to be opened and actuate a second switch 442 to be closed to connect the discharge positive electrode 438 to an electrical circuit including the negative electrode 412 and the electrolyte 416.

Referring again to FIG. 2, in instances in which a charge positive electrode has pores through which electrolyte is transportable from the negative electrode to the discharge positive electrode, selectively switching operation of at least one electrochemical cell according to step 268 of the exemplary method 260 may include removing the discharge positive electrode from the electrolyte to interrupt electrical communication between the discharge positive electrode and the negative electrode.

While certain arrangements of charge positive and discharge positive electrodes have been described, other arrangements are additionally or alternatively possible.

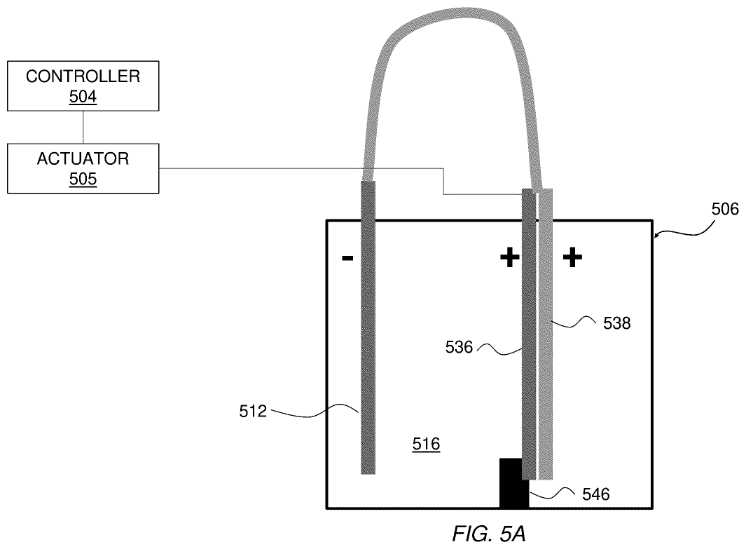

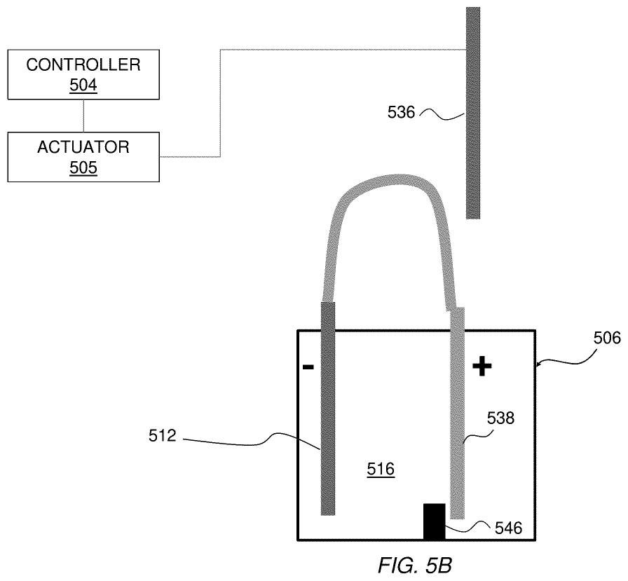

For example, referring now to FIGS. 5A and 5B, an electrochemical cell 506 may include a negative electrode 512, an electrolyte 516, a charge positive electrode 536, and a discharge positive electrode 538. The electrochemical cell 506 may include a controller 504 in electrical communication with at least one instance of an actuator 505, and the controller 504 may be operable to actuate the at least one instance of the actuator 505 to move the charge positive electrode 536 into and out of the electrolyte 516.

The charge positive electrode 536 may be nonporous and impermeable to the electrolyte 516 such that movement of the charge positive electrode 536 into and out of the electrolyte 516 may be used to shield the discharge positive electrode 538 in the electrolyte 516. For example, in the charge mode of the electrochemical cell 506, the charge positive electrode 536 may be seated in a frame 546 such that the charge positive electrode 536 blocks transport of ions, through the electrolyte 516, from the negative electrode 512 to the discharge positive electrode 538. In such instances, during operation of the electrochemical cell 506 in charge mode, there is little or no direct pathway for ions to travel to the discharge positive electrode 538. This can be useful, for example, because blocking the ionic pathway to the discharge positive electrode 538 may reduce the rate of oxidative degradation of the discharge positive electrode 538.

Additionally, or alternatively, during operation of the electrochemical cell 506 in the discharge mode, the controller 504 may be operable to actuate the at least one actuator 505 to lift the charge positive electrode 536 out of the electrolyte 516. The controller 504 may further, or instead, be operable to actuate the at least one instance of the actuator 505 to lower the charge positive electrode 536 back into the electrolyte 516 when switching from discharge mode to charge mode, and the charge positive electrode 536 may be secured in position in the electrolyte 416 by insertion into the frame 546.

The discharge positive electrode 538 may remain in the electrochemical cell 506 during both charge and discharge mode in some implementations. This can be advantageous, for example, because the discharge positive electrode 538 may be more difficult to remove from the electrochemical cell 506, as compared to the charge positive electrode 536, because the discharge positive electrode 538 may have more components (e.g., gas inlet manifold, flow field, and/or gas outlet).

Having described various aspects of systems and methods of bidirectional operational control of an electrowinning plant using an electrochemical cell in charge mode and in discharge mode, it shall be appreciated that aspects of these systems and methods may be carried out in separate electrochemical cells.

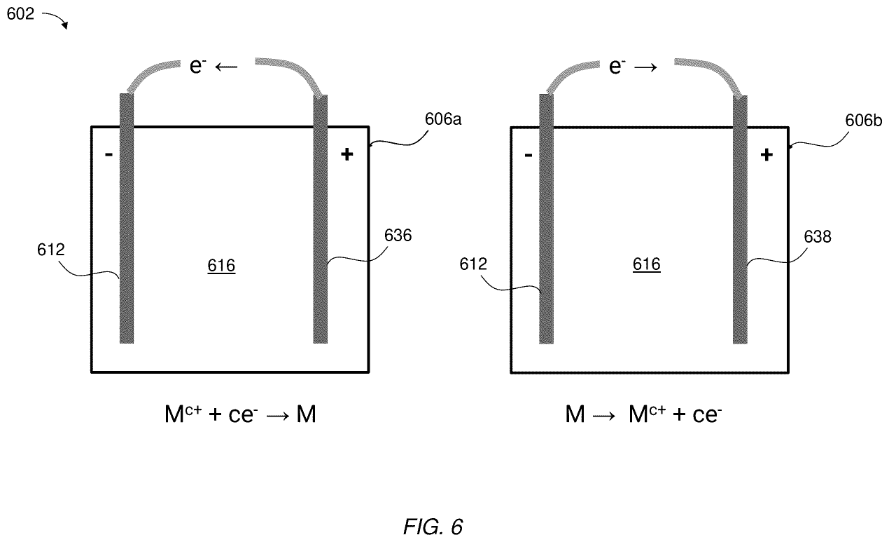

For example, referring now to FIG. 6, a system 602 for bidirectional operational control of an electrowinning plant may include a first electrochemical cell 606a and a second electrochemical cell 606b. The first electrochemical cell 606a may include a charge positive electrode 636 and a first instance of a negative electrode 612 at least partially submerged in an electrolyte 616 and, thus, may be operable in a charge mode. The second electrochemical cell 606b may include a discharge positive electrode 638 and a second instance of the negative electrode 612 at least partially submerged in the electrolyte 616 and, thus, may be operable in a discharge mode.

In the first electrochemical cell 606a, metal in the zero valence state may be deposited on the first instance of the negative electrode 612 through electrowinning in the first electrochemical cell 602a with the charge positive electrode 636. The product metal (the metal in the zero valence state) may be periodically removed from the first electrochemical cell 606a and stored. When switching to discharge mode (e.g., when additional electricity is needed by a grid or other load), the metal in the zero valence state may be moved (e.g., from storage) to the second electrochemical cell 606b having the discharge positive electrode 638. The second electrochemical cell 606b may then be operated to generate electrical power.

Having described various aspects of systems and methods of bidirectional operational control of electrowinning plants, attention is now directed to certain features of electrowinning plants that may be operationally controlled by any one or more of the systems and methods of bidirectional operational control described herein.

The capital cost of an electrowinning plant may include the costs of tanks that contain the electrodes, busbars to deliver electricity, cranes to move the electrodes from the electrochemical cells to the cleaning/stripping stations, and the building. Each of these components increase in cost as the electrodes are spaced farther apart. An electrochemical cell accommodating the volume of both the discharge positive electrode and the charge positive electrode may, thus, result in higher overall capital cost.

The capital cost may be reduced if the discharge positive electrode fits into the same location in the electrochemical cell as the charge positive electrode. During charge mode, the discharge positive electrode may be in a storage location, and the charge positive electrode may be in the electrochemical cell. When switching from charge mode to discharge mode, the charge positive electrode may be removed from the electrochemical cell and moved to a storage location, and the discharge electrode may be placed into the electrochemical cell. In such implementations, the charge positive electrode may be porous or nonporous.

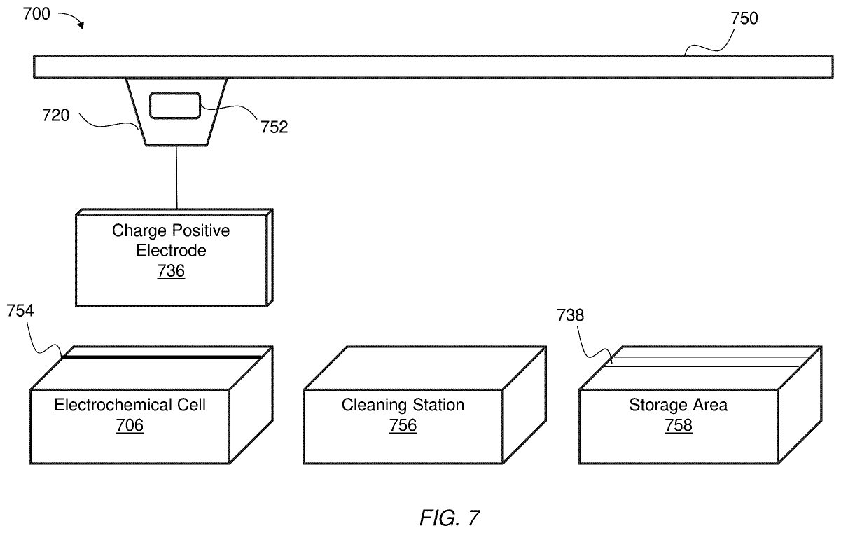

Referring now to FIG. 7, an electrowinning plant 700 may include a crane 720 movable along an overhead gantry 750 such that a motor 752 of the crane 716 may be used to lift one or more electrodes from an electrochemical cell 706. For example, a charge positive electrode 736 may be lifted vertically from a position 754 in the electrochemical cell 706. Further, or instead, the crane 720 traveling on the overhead gantry 750 may move the charge positive electrode 736 to a cleaning station 756 and/or to a storage area 758.

To operate the electrochemical cell 706 in a discharge mode, the crane 720 may be controlled to lift a discharge positive electrode 738 from the storage area 758, move the discharge positive electrode 738 horizontally over the electrochemical cell 706, and lower the discharge positive electrode 738 into the position 754 previously occupied by the charge positive electrode 736.

While electrochemical cells have been described as including a single negative electrode paired with one or two positive electrodes, it shall be appreciated that other electrode arrangements are within the scope of the present disclosure. For example, unless otherwise specified or made clear from the context, it shall be appreciated that multiple anodes and cathodes may be placed in an electrolyte in a large tank. The anodes within the tank may be connected to each other in parallel, and the cathodes may be connected to each other in parallel within a tank. In such implementations, typical tank may contain 10 to 100 cathodes or any appropriate number of cathodes.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

While particular embodiments have been shown and described, it will be apparent to those skilled in the art that various changes and modifications in form and details may be made therein without departing from the spirit and scope of this disclosure and are intended to form a part of the invention as defined by the following claims.

What is claimed is:

1. A method of controlling bidirectional operation of an electrowinning plant, the method comprising:
receiving a supply of metal in an oxidized state into at least one electrochemical cell;
operating the at least one electrochemical cell in a charge mode in which a first electric current applied across the electrochemical cell reduces the metal from the oxidized state to a zero valence state in the electrochemical cell;
operating the at least one electrochemical cell in a discharge mode in which oxidation of at least some of the metal from the zero valence state to the oxidized state in the electrochemical cell generates a second electric current oppositely charged relative to the first electric current; and
selectively changing operation of the at least one electrochemical cell between the charge mode and the discharge mode.

2. The method of claim 1, wherein the metal in the oxidized state includes metal ore.

3. The method of claim 1, wherein the metal includes one or more of iron, copper, zinc, nickel, manganese, lead, aluminum, or cobalt.

4. The method of claim 1, wherein operating the at least one electrochemical cell in the discharge mode includes inserting an additional amount of the metal in the zero valence state into the electrochemical cell.

5. The method of claim 1, wherein operating the at least one electrochemical cell in the charge mode includes receiving power from a power network to apply the first electric current across the electrochemical cell, and operating the at least one electrochemical cell in the discharge mode includes delivering, to the power network, at least some of the power generated by the electrochemical cell.

6. The method of claim 1, wherein operating the at least one electrochemical cell in the charge mode includes applying the first electric current across a negative electrode and at least one positive electrode, via an electrolyte therebetween, with the negative electrode including the metal in the oxidized state.

7. The method of claim 1, wherein selectively changing operation of the at least one electrochemical cell between the charge mode and the discharge mode includes operating the at least one electrochemical cell in the discharge mode for greater than about 1 percent and less than about 13 percent of time that the at least one electrochemical cell is in the charge mode.

8. The method of claim 1, wherein selectively changing operation of the at least one electrochemical cell between the charge mode and the discharge mode includes operating the at least one electrochemical cell in the charge mode for about 1 day to about 30 days between harvesting.

9. The method of claim 1, wherein selectively changing operation of the at least one electrochemical cell is based on a parameter associated with operation of the at least one electrochemical cell compared to a predetermined target value of the parameter.

10. The method of claim 1, wherein the at least one electrochemical cell includes a plurality of electrochemical cells, operating the at least one electrochemical cell in the charge mode includes operating a first one of the plurality of electrochemical cells in the charge mode, operating the at least one electrochemical cell in the discharge mode includes operating a second one of the plurality of electrochemical cells in the discharge mode, and selectively changing operation of the at least one electrochemical cell between the charge mode and the discharge mode includes controlling electrical communication between a power network and the first one and the second one of the plurality of electrochemical cells.

11. The method of claim 1, further comprising harvesting at least a portion of the metal in the zero valence state from the at least one electrochemical cell.

12. A system for bidirectional operational control of an electrowinning plant, the system comprising:
at least one electrochemical cell into which a supply of metal is receivable; and
a controller actuatable to change operation of the one or more electrochemical cells between a charge mode and a discharge mode, the one or more electrochemical cells in the charge mode operable to reduce metal from an oxidized state to a zero valence state in response to a first electric current applied to the one or more electrochemical cells, and the one or more electrochemical cells in the discharge mode operable to oxidize the metal from the zero valence state to the oxidized state such that a second electric current, oppositely charged relative to the first electric current, is generated by the one or more electrochemical cells.

13. The system of claim 12, wherein the at least one electrochemical cell includes at least one positive electrode, a negative electrode, an electrolyte in fluid communication between the at least one positive electrode and the negative electrode, the at least one electrochemical cell is operable in the charge mode with the first electric current applied across the negative electrode and the at least one positive electrode, via the electrolyte therebetween and with the negative electrode including the metal in the oxidized state, and the at least one electrochemical cell is operable in the discharge mode with the second electric current generated across the negative electrode and the at least one positive electrode, via the electrolyte therebetween and with the negative electrode including metal in the zero valence state.

14. The system of claim 13, wherein the negative electrode is removable from the at least one electrochemical cell and, with the negative electrode removed from the electrochemical cell, at least a portion of the metal in the zero valence state is harvestable from the negative electrode.

15. The system of claim 13, wherein the at least one positive electrode includes a charge positive electrode and a discharge positive electrode, and each one of the charge positive electrode and the discharge positive electrode is electrically decouplable from the negative electrode and from one another.

16. The system of claim 13, wherein the at least one positive electrode includes a bifunctional oxygen electrode having hydrophobic pores and hydrophilic pores.

17. The system of claim 12, wherein the controller is actuatable to activate one or more switches in electrical communication between the at least one electrochemical cell and a power network to change operation of the at least one electrochemical cell between the charge mode and the discharge mode, power from the power network is receivable by the at least one electrochemical cell in the charge mode, and at least some of the power generated by the at least one electrochemical cell is deliverable to the power network with the at least one electrochemical cell in the discharge mode.

18. The system of claim 12, wherein the at least one electrochemical cell is operable in the discharge mode for greater than about 1 percent and less than about 13 percent of the time the at least one electrochemical cell is in the charge mode.

19. The system of claim 12, wherein the controller is actuatable to change operation of the at least one electrochemical cell such that the at least one electrochemical cell operates in the charge mode for about 1 day to about 30 days between harvesting.

20. The system of claim 12, wherein the at least one electrochemical cell includes a plurality of electrochemical cells, a first one of the plurality of electrochemical cells is operable in the charge mode, a second one of the plurality of electrochemical cells is operable in the discharge mode, and the controller is actuatable to control electrical communication between a power network and the first one and the second one of the plurality of electrochemical cells.
